(19) United States
(12) Patent Application Publication
(10) Pub. No.: US 2017/0270418 A1
(43) Pub. Date: Sep. 21, 2017

(54) POINT IN TIME PREDICTIVE GRAPHICAL MODEL EXPLORATION

(71) Applicant: Roam Analytics, Inc, San Francisco, CA (US)

(72) Inventors: Kevin Reschke, San Francisco, CA (US); Atul Suklikar, San Francisco, CA (US); Andrew Maas, San Francisco, CA (US); Christopher Potts, San Francisco, CA (US)

(21) Appl. No.: 15/070,267

(22) Filed: Mar. 15, 2016

(51) Int. Cl. G06N 7/00; G06F 3/0484

(52) U.S. Cl. CPC G06N 7/005; G06F 3/04847; G06F 3/04842

(57) ABSTRACT

In various example embodiments, a system and methods are presented for generation and manipulation of predictive models within a user interface. The system and methods receive a view query with object data and time data and generate a user interface having a first graphical representation of a set of historical data responsive to the view query. The systems and methods generate a predictive model based on the set of historical data and generate a second graphical representation for the predictive model. The systems and methods generate and monitor a movable pivot element to automatically modify the predictive model and second graphical representation upon a change in position of the pivot element.

### TECHNICAL FIELD

Embodiments of the present disclosure relate generally to user interface interactions and, more particularly, but not by way of limitation, to modeling and manipulating related predictive models within a graphical user interface.

### BACKGROUND

Conventionally, systems and methods for data modeling generate models through intentional user interaction and request. These systems often require the user to be familiar with both the subject and context of the models and also with the systems, procedures, and assumptions used to generate a model. Further, the data models generated by these systems often model a single predetermined attribute of the underlying data, taking into account only the characteristics of the data directly influencing the predetermined attribute.

Display of data models is conventionally static, requiring separate generation of models prior to rendering new data on a user interface. User interfaces for display of the data models often require direct interaction with predetermined fields and an understanding of appropriate data or queries to be entered in the fields in order to refresh of an existing model or change to a differing model.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram of an example predictive modeling system, according to various embodiments.

FIG. 3 is a flowchart illustrating an example method of generating and manipulating related predictive models within a graphical user interface, according to various embodiments.

FIG. 4 is an example interface diagram illustrating a user interface screen of a predictive modeling system, according to various embodiments.

FIG. 5 is a flowchart illustrating an example method for generating and manipulating related predictive models within a graphical user interface, according to various embodiments.

FIG. 6 is an example interface diagram illustrating a user interface screen of a predictive modeling system, according to various embodiments.

FIG. 7 is a flowchart illustrating an example method of generating and manipulating related predictive models within a graphical user interface, according to various embodiments.

FIG. 8 is a block diagram illustrating an example of a software architecture that may be installed on a machine, according to some example embodiments.

FIG. 9 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Systems and methodologies described herein enable generation of a user interface as well as predictive models which allow a user to rapidly explore a wide array of related predictive models. The user may identify causal factors in data presented within the user interface. The systems and methodologies may enable the user to add annotations identifying the causal factors and factors or events desired by the user to iteratively adjust or modify the predictive models. The methodologies and systems presented herein achieve a synthesis between domain expert knowledge and model predictions without the domain expert having direct access or knowledge of the underlying predictive models.

User interface elements of the user interface described by the systems and methods of the present disclosure enable pivot changes and modifications of predictive models based on positioning of a pivot element. Changes in position of the pivot element may act as a query causing a change in later predictions. The results of the predictive model may be overlaid or otherwise contemporaneously displayed with historical data. Further, each movement causes the generation of a new predictive model incorporating previous iterations of predictive models and changes to the pivot element to focus on a specified or selected aspect of the historical data presented.

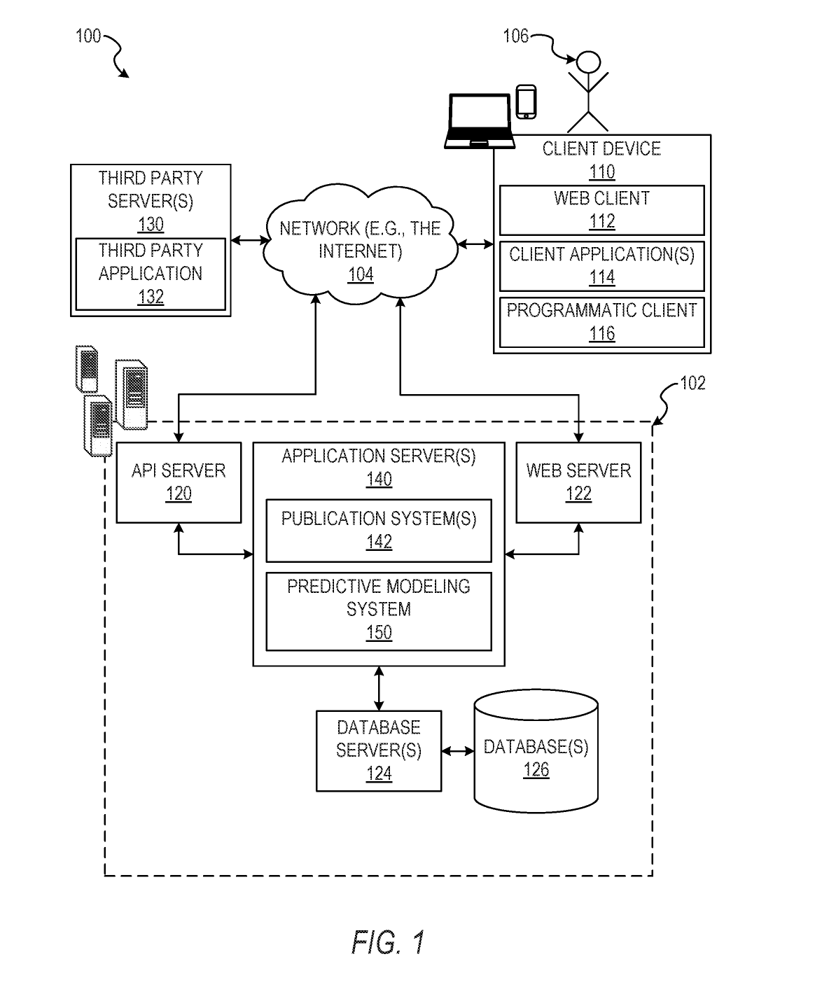

With reference to FIG. 1, an example embodiment of a high-level client-server-based network architecture 100 is shown. A networked system 102, in the example forms of a network-based predictive modeling system, provides server-side functionality via a network 104 (e.g., the Internet or wide area network (WAN)) to one or more client devices 110. FIG. 1 illustrates, for example, a web client 112 (e.g., a browser, such as the INTERNET EXPLORER® browser developed by Microsoft® Corporation of Redmond, Washington State), an application 114, and a programmatic client 116 executing on client device 110.

The client device 110 may comprise, but is not limited to, mobile phones, desktop computers, laptops, personal digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display component (not shown) to display information (e.g., in the form of user interfaces). In further embodiments, the client device 110 may comprise one or more of a touch screens, accelerometers, gyroscopes, cameras, microphones, global positioning system (GPS) devices, and so forth.

The client device 110 may be a device of a user that is used to perform a transaction involving object data and predictive models within the networked system 102. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks. Each of the client device 110 may include one or more applications (also referred to as “apps”) such as, but not limited to, a web browser, messaging application, electronic mail (email) application, and the like.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 may host one or more publication systems 142 and predictive modeling systems 150, each of which may comprise one or more components or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store object data, historical data, and predictive modeling data in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party.

The publication system 142 may provide a number of publication, archival, and data storage functions and services to users 106 that access the networked system 102. For example, the publication system 142 may gather, publish, and store object data, historical data for one or more objects, sales data for one or more objects, revenue data for one or more objects, release data for one or more objects, and competitor data for one or more objects. The publication system 142 may publish the object data and data related to the objects to an internal database or publicly available database to enable generation of predictive models based on the object data and data related to the objects. In some embodiments, the publication system 142 accesses one or more third party servers or databases (e.g., the third party server 130) to retrieve, modify, and provision the object data within the database 126.

The predictive modeling system 150 may provide functionality operable to perform various predictive model generation and manipulation functions, as well as functions for generating graphical representations of object data, data related to the objects, and predictive models. For example, the predictive modeling system 150 accesses sets of object data from the databases 126, the third party servers 130, the publication system 142, the client device 110, and other sources. In some example embodiments, the predictive modeling system 150 analyzes portions of the sets of object data to generate predictive models forecasting one or more aspects or characteristics of the object or performance of the object with respect to a predetermined or defined metric. In some example embodiments, the predictive modeling system 150 communicates with the publication systems 142 to access the sets of object data and transmit queries received by the predictive modeling system 150 to the publication system 142. In an alternative embodiment, the predictive modeling system 150 may be a part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142 and predictive modeling system 150 could also be implemented as standalone software programs, which do not necessarily have networking capabilities.

The web client 112 may access the various publication and predictive modeling systems 142 and 150 via the web interface supported by the web server 122. Similarly, the programmatic client 116 accesses the various services and functions provided by the publication and predictive modeling systems 142 and 150 via the programmatic interface provided by the API server 120.

Additionally, a third party application(s) 128, executing on a third party server(s) 130, is shown as having programmatic access to the networked system 102 via the programmatic interface provided by the API server 114. For example, the third party application 128, utilizing information retrieved from the networked system 102, may support one or more features or functions on a website hosted by the third party. The third party website may, for example, provide one or more promotional, marketplace, data repository, company interaction, or object tracking functions that are supported by the relevant applications of the networked system 102.

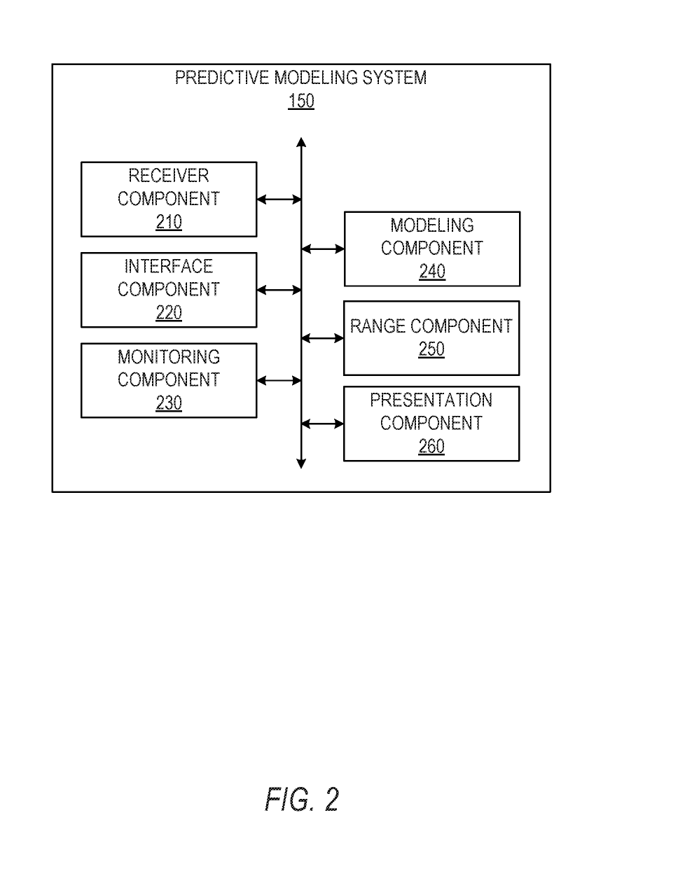

FIG. 2 is a block diagram illustrating components of the predictive modeling system 150, according to some example embodiments. The predictive modeling system 150 is shown as including a receiver component 210, an interface component 220, a monitoring component 230, a modeling component 240, a range component 250, and a presentation component 260 all configured to communicate with one another (e.g., via a bus, shared memory, or a switch). Any one or more of the components described herein may be implemented using hardware (e.g., one or more processors of a machine) or a combination of hardware and software. For example, any component described herein may configure a processor (e.g., among one or more processors of a machine) to perform operations for which that component is designed. Moreover, any two or more of these components may be combined into a single component, and the functions described herein for a single component may be subdivided among multiple components. Furthermore, according to various example embodiments, components described herein as being implemented within a single machine, database(s) 126, or device (e.g., client device 110) may be distributed across multiple machines, database(s) 126, or devices.

The receiver component 210 receives or otherwise accesses object data for generation and provisioning of object data, historical data, and predictive modeling. In some embodiments, the receiver component 210 receives queries from the client device 110 to access specified aspects of the object data and historical data to enable generation of predictive models. The interface component 220 generates user interfaces and user interface elements through which the client device 110, operated by the user 106, accesses and interacts with the object data, historical data, and predictive models.

The monitoring component 230 monitors one or more user interface elements generated by the interface component 220 to trigger automated operations with respect to generating or modifying predictive models and displaying data underlying the generated predictive models. The modeling component 240 generates one or more predictive models based on retrieved or accessed object data and historical data. In some embodiments, the modeling component 240 generates and modifies the predictive models automatically based on indirect user interaction with the user interface or user interface elements, without the user 106 or the client device 110 directly specifying or requesting generation or modification of the predictive models. The range component 250 identifies time data related to the object data and historical data and communicates specified characteristics of the time data to the interface component for generation of portions of the user interface and the one or more user interface elements.

The presentation component 260 causes presentation of the user interface and user interface elements generated by the interface component 220 to the client device 110. In some embodiments, the presentation component 260 causes presentation by transmitting the use interfaces and user interface elements to the client device 110 over the network 104. The presentation component 260 may operate in cooperation with one or more of the receiver component 210 and the monitoring component 230 to monitor interaction with the user interface and user interface elements at the client device 110.

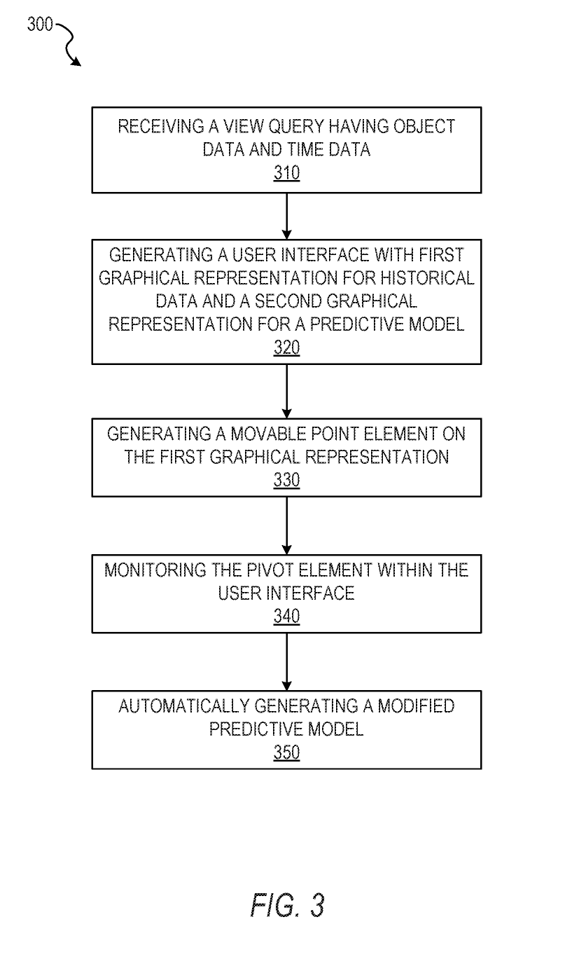

FIG. 3 is a flowchart of operations of the predictive modeling system 150 in performing a method 300 of generating and manipulating related predictive models within a graphical user interface, according to some example embodiments. Operations in the method 300 may be performed by the predictive modeling system 150, using components described herein.

In operation 310, the receiver component 210 receives a view query comprising object data and time data. The object data and the time data are associated with a set of historical information for a specified object. The view query may also include multivariate time series modeling input. In some embodiments, the view query is received by the receiver component 210 through a request entered in a user interface generated by the interface component 220 and presented at the client device 110. For example, the interface component 220 may generate a user interface with one or more data entry fields. In some instances, the view query, as received by the receiver component 210 through the user interface, may be formatted to query the database 126 to retrieve a set of historical data representative of an object. In some embodiments, the receiver component 210 may configure or otherwise format the view query to query the database 126.

The view query may be passed to the database 126 by the receiver component 210 to access a knowledge base within the database 126 to surface contextually relevant objects and information relating to the objects. For example, the object may be a product, and the database 126 provisions product information, events, news articles, sales information, profitability information, competing products, competitor companies, related products or product lines, dates for release of the product, dates for release of related products, dates for termination of a product line, and other object information. In some embodiments, where the view query includes time data, the contextually relevant objects and information may be determined in part based on the time data. For example, the objects and information may be determined based on a start date, an end date, a time range, or other time data included in the query view.

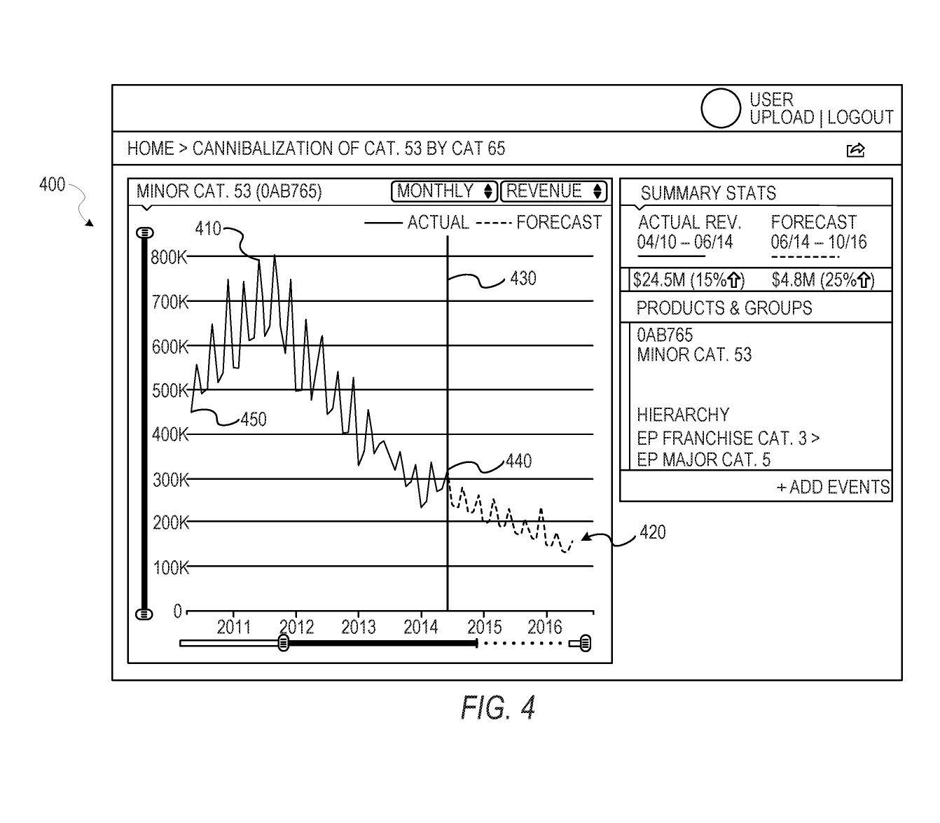

In operation 320, the interface component 220 generates a user interface with a first graphical representation and a second graphical representation. The first graphical representation represents a set of historical data and the second graphical representation represents a predictive model based on at least a portion of the set of historical data. In some embodiments, the second graphical representation extends outwardly from the first graphical representation at a point along the first graphical representation. The second graphical representation may extend outwardly from the first graphical representation as a continuation of the first graphical representation. For example, where the first graphical representation is a graphed line, the second graphical representation may be a portion of the graphed line continuing past an ending point of the first graphical representation. In some instances, the first graphical representation and the second graphical representation may be differentiated based on a change in color, a change in line type (e.g., solid or dotted), a change in direction of the first graphical representation to the second graphical representation, or other change in appearance. In some instances, as shown in FIG. 4, the first graphical representation may be a first graphical plot of a set of historical data. The second graphical representation may be a second graphical plot of a set of predicted data. The first graphical plot and the second graphical plot may form a combined graphical plot or line representing both the historical data and predicted data.

In some instances, the set of historical data may be presented as a graph, as shown in FIG. 4. For example, the user interface may be generated as a set of time series data, displayed with time along an x axis and quantity or quantities along a y axis. As shown, the set of historical data may include the quantity or quantities displayed along the y axis. The set of historical data may include actual available data or smoothed interpolations from it. The set of historical data may be understood as ground truth of the object associated with the set of historical data. In FIG. 4, the user interface 400 is depicted as a graph with the first graphical representation 410 for the historical data extending across the x and y axes of the graph and the second graphical representation 420 extending across the x and y axes of the graph.

Each of the predictive models, generated by the modeling component 240, may be a machine learning model that is multiply cross-validated on the available data. Cross-validation may be performed in varying ways based on a size of a data set and a distribution of individual values within the data set. In some instances, the modeling component 240 may generate N folds of the available data and use N-1 of the folds to set parameters and train the machine learning model. The modeling component 240 may then evaluate the machine learning model and cross-validation based on the remaining fold of the available data. The folds may be understood as subsamples of the available data, divided for use in cross-validation operations. In some instances, the folds represent equal sized subsamples of the available data. In some instances, the folds may represent subsamples divided into a distribution of available data based on relationships determined among the available data.

In some embodiments, the available data may be the set of historical data provided by the database 126 in response to the view query. The available data may also include additional information supplied by the database 126 in response to the view query which is not presented within the user interface. The available data may also include additional information not supplied for presentation within the user interface but included within the database 126 and identified in response to the view query. In some instances, additional information may include external financial data relating to the current analysis or broader economic climate, dated events falling into predetermined classes (e.g., a recall or a product launch), and data sets relating to entities in the database being examined.

The process of cross-validation may set a number of hyper-parameters to the model. The hyper-parameters may be set or otherwise determined by grid search, Bayesian parameter search, and other suitable methods. In some embodiments, the hyper-parameters may have a range of potential values. Grid search methods may be used to systematically search through combinations of all potential values for all of the hyper-parameters. Bayesian methods may ignore certain combinations that are determined to provide theoretically sub-optimal given results in favor of other combinations providing differing results. The hyper-parameters control one or more aspects of the analysis, including which features of the data are kept in the model, the relative weights of those features, the relative importance of each input data point, the choice of learning objective, and the choice of optimization algorithm to use. The hyper-parameters of the model may be understood to be parameters which are determined and set during a learning phase of generating the machine learning models.

The process of generating and modifying the predictive models may avoid over-fitting to the available data. For example, in some instances, the process is repeated with different subsets of the available data and repeatedly assessed on held-out portions of the data (i.e., cross-validated) to avoid over-fitting In some embodiments, the predictive models enable inference and generalization of the set of historical data.

Referring again to FIG. 3, in operation 330, the interface component 220 generates a movable pivot element. In some embodiments, the pivot element is a user interface element initially depicted in a first position on the first graphical representation. The movable pivot element may intersect the first graphical representation and is movable along the first graphical representation. As shown in FIG. 4, a movable pivot element 430 may be a draggable pivot line intersecting the first graphical representation. The movable pivot element may dynamically set a pivot time. In some embodiments, the pivot time marks a point in time acting as a bound for generating the predictive model. The pivot time may be an end bound (e.g., an end time) for generating the predictive model. Where the pivot time is an end bound 440, a start bound 450 may be a starting time for the set of historical data. In some embodiments, the starting time is the earliest time available for the set of historical data on the database 126. The starting time may be the earliest time depicted within the user interface for the set of historical data (e.g., the time range of the view query). The pivot time may also be a point on the first graphical representation at which the second graphical representation begins and from which the second graphical representation may extend. Depicting the first graphical representation and the second representation within the same user interface enables direct comparison of the ground truth with a generated predictive model.

In some embodiments, the predictive model generated in operation 320 is generated based on a portion of the set of historical data represented by the first graphical representation extending from a first end of the first graphical representation to the first position of the pivot element. In these embodiments, the second graphical representation extends outwardly from the first graphical representation at the position of the pivot element on the first graphical representation. Adjusting the pivot element enables exploration of a plurality of predictive models within a given time period (e.g., hundreds of different models in any given second).

In operation 340, the monitoring component 230 monitors the pivot element within the user interface to detect a change in position of the pivot element from the first position to a second position. In some embodiments, the monitoring component 230 uses one or more JavaScript operations or functions for identifying interaction with the user interface such as mouse movements or clicks, touches, keyboard events, and other suitable user interface interactions. The monitoring component 230 may monitor the pivot element based on the position of the pivot element with respect to a pixel position of the displayed user interface, a position on the first graphical representation, a change in position along a Cartesian coordinate system, or any other user interface element tracking method.

In operation 350, the modeling component 240 automatically modifies the predictive model to generate a modified predictive model. In some embodiments, in response to the generation of the modified predictive model, the interface component 220 modifies the second graphical representation to represent the modified predictive model. The modeling component 240 may modify a previously generated predictive model based on feedback loops to circle back to previous models in differing ways based on a selected feedback loop or a specified input of one or more differing feedback loops.

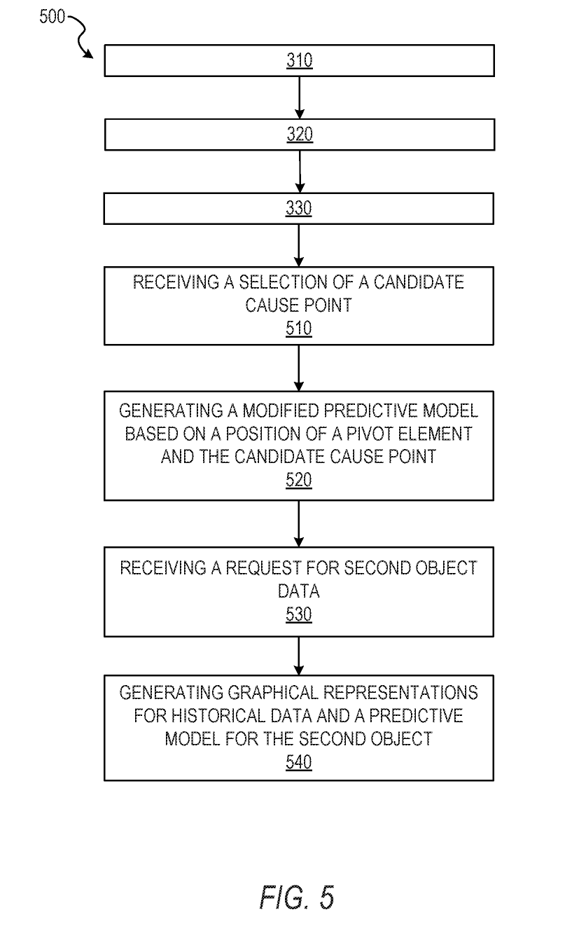

FIG. 5 is a flow chart of operations of the predictive modeling system 150 in performing operations of a method 500 of generating and manipulating related predictive models within a graphical user interface, according to some example embodiments. The operations depicted in FIG. 5 may be performed by the predictive modeling system 150, using components described herein. As shown in FIG. 5, in some embodiments, the method 500 may be performed as a part of or sub-operations of the method 300, described above.

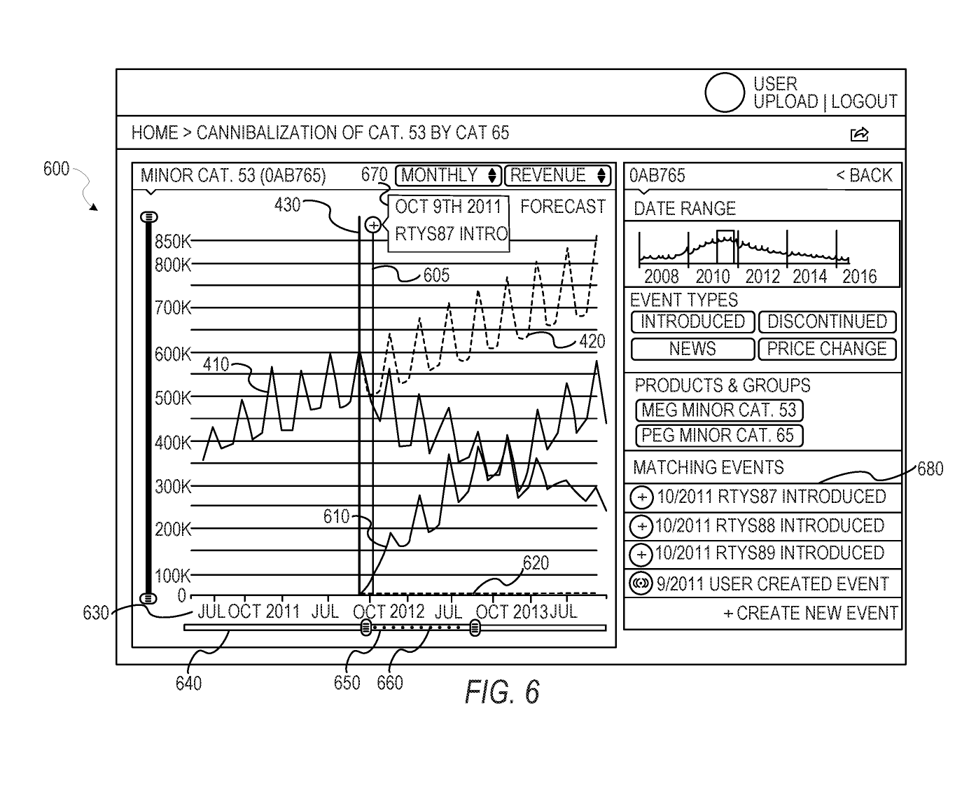

In operation 510, the receiver component 210 receives a selection of a candidate cause point 605 within the user interface 600 shown in FIG. 6. In some embodiments, the candidate cause point 605 is a point on the first graphical representation after which the second graphical representation deviates from the first graphical representation when the pivot element is located at the candidate cause point 605. The candidate cause point 605 may be selected by the receiver component 210 receiving a user interaction with the user interface, such as a mouse click, a tap of a touchscreen, or other interaction. In some instances, if a predictive model from a pivot time becomes inaccurate or deviates from at least a portion of the first graphical representation (e.g., the set of historical data) beyond a suitable threshold, selection of the candidate cause point 605 may indicate a cause of the deviation.

In operation 520, the modeling component 240 generates a modified predictive model based on the second position of the pivot element and the candidate cause point 605. The modeling component 240 may incorporate an event, change in the set of historical data, or other aspect of the first graphical representation indicated by the candidate cause point 605 into generating the modified model to enhance accuracy or better fit the modified predictive model to the portion of the set of historical data from which it previously deviated. Selection of the candidate cause point 605 may increase the relevance and accuracy of a given model and enable inclusion of similar events into future predictive models without subsequent user interaction. The candidate cause represented by the candidate cause point 605 may be used as an additional predictor in the model and may be incorporated into the model free fit using one or more techniques described in the present disclosure.

In operation 530, the receiver component 210 receives a request for second object data. In some embodiments, the second object data is rendered and replaces previously received object data, predictive models, and graphical representations. As shown in FIG. 6, the second object data is rendered on a user interface 600 with the first object data, predictive model, the first graphical representation 410, and the second graphical representation 420. The second object may be related to the first object and be represented within the database 126 by object identifiers, historical data for one or more objects, sales data for one or more objects, revenue data for one or more objects, release data for one or more objects, and competitor data for one or more objects. The second object may be identified as related to the first object based on matching categories of the first object and the second object, matching a temporal component (e.g., time data) between the first object and the second object, or determining one or more other similarities among the object data of the first object and the second object. In some embodiments, the second object may be identified based on inferences drawn on the first graphical representation and the second graphical representation within the user interface. The inferences may be drawn by the predictive modeling system 150 based on the generated user interface presented to the client device 110. The predictive modeling system 150 may query the database 126 (e.g., the knowledge base) to surface objects determined to be relevant to the product and the current model. The predictive modeling system 150 may additionally surface results for the second object by queries received from the client device 110 based on one or more search engine relevance determinations.

Where the second object is related to the first object, the related object (e.g., a related product or product group) may be displayed within the graphical user interface as described below. Related objects may include products, product groups, events (e.g., system generated events, manually added events, events sourced from publicly available databases), accounts, and manually created adjustments. Objects, object representations, and historical data points of the set of historical data may be hyperlinked to one or more resource locations (e.g., an address within the publication system 142). In some embodiments, the hyperlinks enable users to change the context of a generated user interface (e.g., user modified or system generated context changes) and drill into details of displayed objects or displayed object data.

In operation 540, the interface component 220 generates a third graphical representation 610 of a subsequent set of historical data (e.g., a set of historical data of the second object) and a fourth graphical representation 620 of a subsequent predictive model (e.g., a predictive model for the second object). As described herein, the third graphical representation 610 and the fourth graphical representation 620 may be associated with the second object. In some embodiments, the operation 540 may be performed similarly to or the same as the operation 320.

In some embodiments, as shown in FIG. 6, once the third graphical representation 610 and the fourth graphical representation 620 have been rendered, the pivot element 430 intersects one or more graphical representations associated with the first object and one or more graphical representations associated with the second object. As shown in FIG. 6, the third graphical representation 610 and the fourth graphical 620 representation may be presented along with the first graphical 410 representation and the second graphical representation 420. In some instances, the third graphical representation 610 and the fourth graphical representation 620 may be presented in a separate user interface (e.g., a separate tab, a separate window, a separate graph positioned proximate to a graph presenting the first graphical representation and the second graphical representation). Where presented in a separate user interface, the pivot element 430 may be configured to be synchronized between the separate user interfaces.

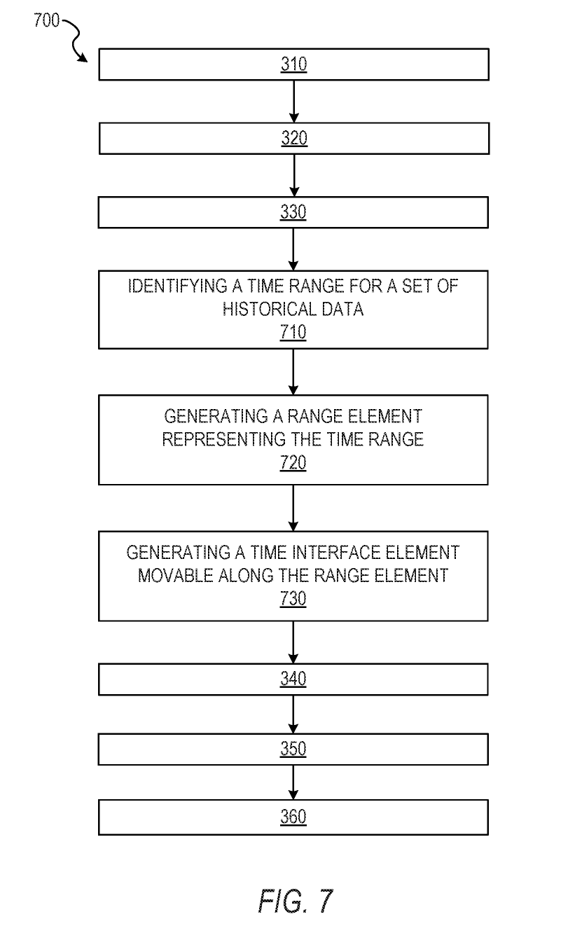

FIG. 7 is a flow chart of operations of the predictive modeling system 150 in performing operations of a method 700 of generating and manipulating related predictive models within a graphical user interface, according to some example embodiments. The operations depicted in FIG. 7 may be performed by the predictive modeling system 150, using components described herein. In some embodiments, as shown in FIG. 7, the method 700 may be performed as part of or as sub-operations of the method 300, described above.

In operation 710, the range component 250 identifies a time range 630, as shown in FIG. 6, for the set of historical data. In some embodiments, the time range may be identified from the view query, the set of historical data, available object data from the database 126, publicly available databases, or any other suitable data source. Once identified by the range component 250, the range component 250 passes the identified time range to the interface component 220.

In operation 720, the interface component 220 generates a range element 640 representing the time range. The range element 640 may be a user interface element indicating or positioned proximate to an indication of the time range. For example, as shown in FIG. 6, the range element 640 is positioned proximate to an x axis of a graph (e.g., the time range 630), where the x axis provides a time measurement indicating intervals of time. In FIG. 6, the range element 640 is a track for a slider. In some embodiments, the range element 640 extends a length of the graph including the graphical representations of one or more objects. In some instances, the range element 640 extends along a portion of the graph, based on the set of historical data and the graphical representations of the set of historical data. In these embodiments where the range element 640 is based on the set of historical data, the range may extend a distance such that display of the graph depicts a portion beyond a terminating edge of the graphical representation of the set of historical data sufficient to portray a portion of a graphical representation of a predictive model. In some embodiments, the portion of the graph extending beyond the set of historical data may be predetermined based on the predictive model or the object data. In some embodiments, the portion of the graph extending beyond the set of historical data may be dynamically determined based on the set of historical data. For example, the portion of the graph beyond the set of historical data may be proportionate to the graph containing the graphical representation of the set of historical data.

In operation 730, the interface component 220 generates a time interface element 650 movable along the range element 640. Movement of the time interface element 650 causes presentation of differing portions of the set of historical data. The range element 640 enables selection of a selected time range (e.g., a subset) from the time range identified in the operation 710. In some embodiments, the time interface element 650 may be a slider or tab within a slider bar or scroll bar. The time interface may be sized based on the time range identified in 710 and the range element 720.

In some embodiments, the time interface element comprises an indicator portion. The indicator portion may include one or more visual indicators 660. A portion of the one or more visual indicators 660 may be configured to provide quick reference data for at least a portion of the time range. The visual indicators 660 of the time interface element 650 may contain markers for events (e.g., peak sales regions or product introduction and discontinuation), sub-ranges, time ranges of one or more sets of historical data of one or more objects, candidate cause elements, or any other suitable information.

In some embodiments, the predictive modeling system 150 may monitor the one or more visual indicators 660 and/or interaction with the one or more visual indicators (e.g., a click of a mouse, a tap of a touchscreen, or hovering of a cursor). In response to the interaction with the one or more visual indicators, the interface component 220 generates and causes display of additional information. For example, the interface component 220 may generate a window 670, overlay, pop-up, new window, or other user interface portion containing the information represented by the selected visual portion. In some embodiments, regardless of interaction with the one or more visual indicators 660, the user interface 600 may display an event window 680 providing information relating to the one or more visual indicators 660.

According to various example embodiments, one or more of the methodologies described herein may facilitate generation and manipulation of predictive models based on a complex set of historical data. Methodologies for generating and modifying the predictive models and user interface elements automatically refresh or modify underlying data and models to determine contextually relevant data and relationships among data stored within the database 126 of the publication system 142. Accordingly, one or more of the methodologies described herein may have the effect of allowing a user to navigate through varying predictive models and assumptions based on historical data, thereby increasing visibility of trends and causal and correlating factors within the historical data.

### Modules, Components, and Logic

Certain embodiments are described herein as including logic or a number of components, modules, or mechanisms. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

Accordingly, the phrase “hardware component” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented component” refers to a hardware component. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

### Machine and Software Architecture

The components, methods, applications and so forth described in conjunction with FIGS. 2-7 are implemented in some embodiments in the context of a machine and an associated software architecture. In various embodiments, the components, methods, applications and so forth described above are implemented in the context of a plurality of machines, distributed across and communicating via a network, and one or more associated software architectures. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here as those of skill in the art can readily understand how to implement the present embodiments in different contexts from the disclosure contained herein.

### Software Architecture

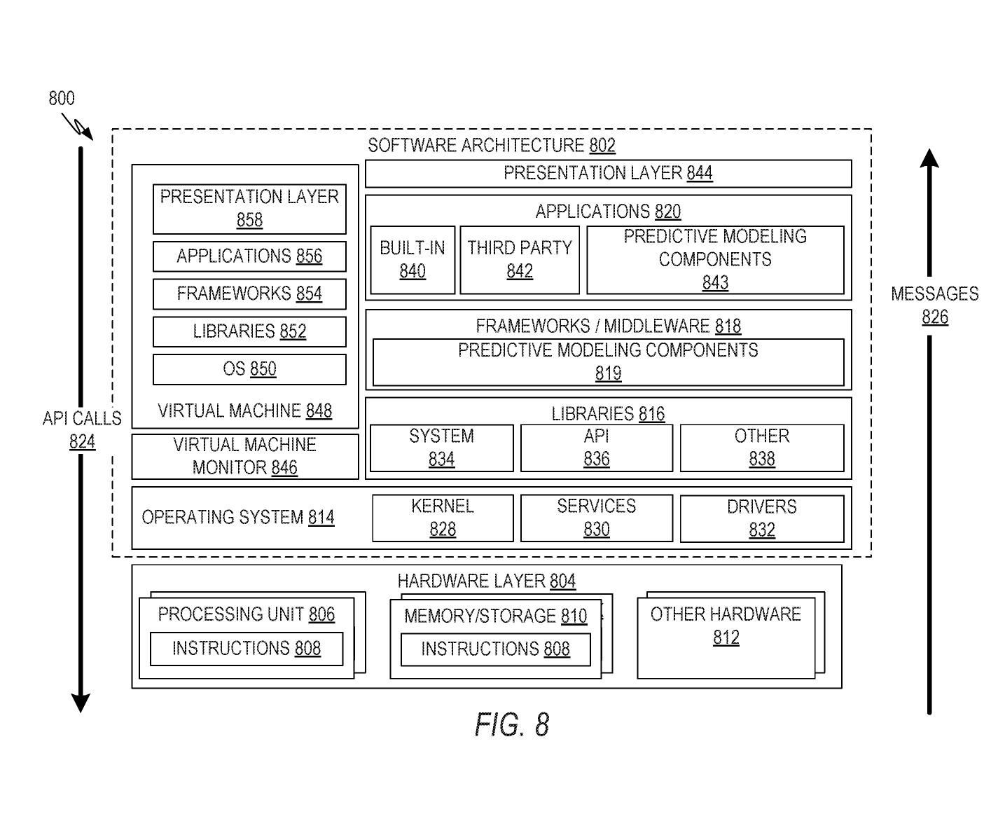

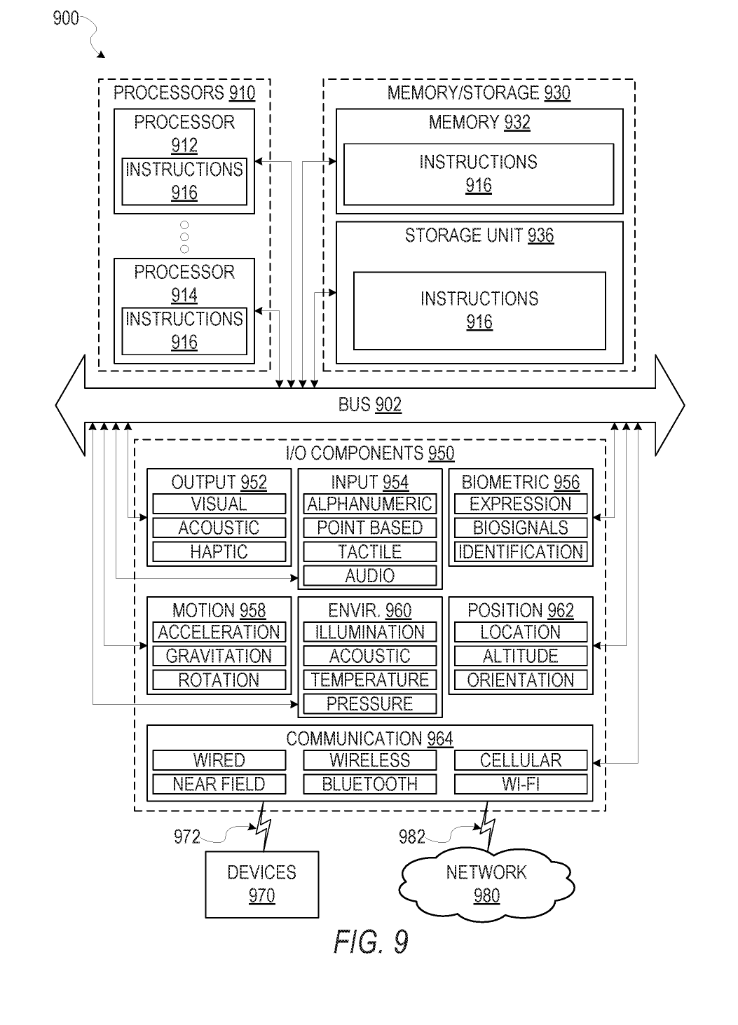

FIG. 8 is a block diagram 800 illustrating a representative software architecture 802, which may be used in conjunction with various hardware architectures herein described. FIG. 8 is merely a non-limiting example of a software architecture and it will be appreciated that many other architectures may be implemented to facilitate the functionality described herein. The software architecture 802 may be executing on hardware such as machine 900 of FIG. 9 that includes, among other things, processors 910, memory 930, and Input/Output (I/O) components 950. A representative hardware layer 804 is illustrated and can represent, for example, the machine 800 of FIG. 8. The representative hardware layer 804 comprises one or more processing units 806 having associated executable instructions 808. Executable instructions 808 represent the executable instructions of the software architecture 802, including implementation of the methods, components, and so forth of FIGS. 2-4. Hardware layer 804 also includes memory and/or storage components 810, which also have executable instructions 808. Hardware layer 804 may also comprise other hardware as indicated by 812, which represents any other hardware of the hardware layer 804, such as the other hardware illustrated as part of machine 900.

In the example architecture of FIG. 8, the software 802 may be conceptualized as a stack of layers where each layer provides particular functionality. For example, the software 802 may include layers such as an operating system 814, libraries 816, frameworks/middleware 818, applications 820, and presentation layer 822. Operationally, the applications 820 and/or other components within the layers may invoke API calls 824 through the software stack and receive a response, returned values, and so forth, illustrated as messages 826 in response to the API calls 824. The layers illustrated are representative in nature and not all software architectures have all layers. For example, some mobile or special purpose operating systems may not provide a frameworks/middleware layer 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software components to perform tasks in an easier fashion than to interface directly with the underlying operating system 814 functionality (e.g., kernel 828, services 830 and/or drivers 832). The libraries 816 may include system 834 libraries (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as Moving Pictures Experts Group 4 (MPEG4), H.264, MP3, Advanced Audio Coding (AAC), Adaptive Multi-Rate (AMR), Joint Photographic Experts Group (JPEG), Portable Network Graphics (PNG)), graphics libraries (e.g., an OpenGL framework that may be used to render two dimensions and three dimensions in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 and/or other software components/modules. For example, the frameworks 818 may provide various graphical user interface functions, high-level resource management, high-level location services, and so forth. The frameworks 818 may provide a broad spectrum of other APIs that may be utilized by the applications 820 and/or other software components/modules, some of which may be specific to a particular operating system or platform. In some example embodiments, predictive modeling components 819 (e.g., one or more components of the predictive modeling system 150) may be implemented at least in part within the middleware/frameworks 818. For example, in some instances, at least a portion of the interface component 220 and the presentation component 260, providing graphical and non-graphical user interface functions, may be implemented in the middleware/frameworks 818. Similarly, in some example embodiments, portions of one or more of the receiver component 210, the monitoring component 230, the modeling component 240, and the range component 250 may be implemented in the middleware/frameworks 818.

The applications 820 include built-in applications 840, third party applications 842, and/or predictive modeling components 843 (e.g., user facing portions of one or more of the components of the predictive modeling system 150). Examples of representative built-in applications 840 may include, but are not limited to, a contacts application, a browser application, a book reader application, a location application, a media application, a messaging application, and/or a game application. Third party applications 842 may include any of the built in applications as well as a broad assortment of other applications. In a specific example, the third party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 842 may invoke the API calls 824 provided by the mobile operating system such as operating system 814 to facilitate functionality described herein. In various example embodiments, the user facing portions of the predictive modeling components 843 may include one or more components or portions of components described with respect to FIG. 2. For example, in some instances, portions of the receiver component 210, the interface component 220, the monitoring component 230, the modeling component 240, the range component 250, and the presentation component 260 associated with user interface elements (e.g., data entry and data output functions) may be implemented in the form of an application.

The applications 820 may utilize built in operating system functions (e.g., kernel 828, services 830 and/or drivers 832), libraries (e.g., system 834, APIs 836, and other libraries 838), frameworks/middleware 818 to create user interfaces to interact with users of the system. Alternatively, or additionally, in some systems interactions with a user may occur through a presentation layer, such as presentation layer 844. In these systems, the application/component “logic” can be separated from the aspects of the application/component that interact with a user.

Some software architectures utilize virtual machines. In the example of FIG. 8, this is illustrated by virtual machine 848. A virtual machine creates a software environment where applications/components can execute as if they were executing on a hardware machine (such as the machine of FIG. 9, for example). A virtual machine is hosted by a host operating system (operating system 814 in FIG. 8) and typically, although not always, has a virtual machine monitor 846, which manages the operation of the virtual machine as well as the interface with the host operating system (i.e., operating system 814). A software architecture executes within the virtual machine such as an operating system 850, libraries 852, frameworks/middleware 854, applications 856 and/or presentation layer 858. These layers of software architecture executing within the virtual machine 848 can be the same as corresponding layers previously described or may be different.

### Example Machine Architecture and Machine-Readable Medium

FIG. 9 is a block diagram illustrating components of a machine 900, according to some example embodiments, able to read instructions (e.g., processor executable instructions) from a machine-readable medium (e.g., a non-transitory machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions may cause the machine to execute the flow diagrams of FIGS. 3, 5, and 7. Additionally, or alternatively, the instructions may implement the receiver component 210, the interface component 220, the monitoring component 230, the modeling component 240, the range component 250, and the presentation component 260 of FIGS. 2-7, and so forth. The instructions transform the general, non-programmed machine into a particular machine programmed to carry out the described and illustrated functions in the manner described.

In alternative embodiments, the machine 900 operates as a standalone device or may be coupled (e.g., networked) to other machines in a networked system. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box, an entertainment media system, a web appliance, a network router, a network switch, a network bridge, or any machine capable of executing the instructions 916, sequentially or otherwise, that specify actions to be taken by machine 900. In some example embodiments, in the networked deployment, one or more machines may implement at least a portion of the components described above. The one or more machines interacting with the machine 900 may comprise, but not be limited to a PDA, an entertainment media system, a cellular telephone, a smart phone, a mobile device, a wearable device (e.g., a smart watch), a smart home device (e.g., a smart appliance), and other smart devices. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 912 and processor 914 that may execute instructions 916. The term “processor” is intended to include multi-core processor that may comprise two or more independent processors (sometimes referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detect sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972, respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, components, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method, comprising:
generating, by one or more processors, a user interface having a first graphical representation of a set of historical data and a second graphical representation of a predictive model, the second graphical representation extending from the first graphical representation;
generating, by the one or more processors, a movable pivot element, the movable pivot element being a user interface element in a first position on the first graphical representation;
monitoring the movable pivot element within the user interface to detect a change in position of the movable pivot element from the first to a second position; and
responsive to the detecting of the change in position of the movable pivot element, automatically modifying the predictive model to generate a modified predictive model and modifying the second graphical representation to represent the modified predictive model.

2. The method of claim 1, wherein the user interface is generated in response to receiving a view query comprising object data and time data, the object data and the time data being associated with the set of historical data.

3. The method of claim 1, wherein the movable pivot element intersects the first graphical representation and is movable along the first graphical representation.

4. The method of claim 1, wherein the predictive model is generated based on a portion of the set of historical data represented by the first graphical representation extending from a first end of the first graphical representation to the first position of the pivot element.

5. The method of claim 1, wherein the second graphical representation extends from the first graphical representation at a position of the pivot element.

6. The method of claim 1 further comprising:
receiving, by the one or more processors, selection of a candidate cause point within the user interface; and
generating the modified predictive model based on the second position of the pivot element and the candidate cause point.

7. The method of claim 6, wherein the candidate cause point is a point on the first graphical representation after which the second graphical representation deviates from the first graphical representation when the pivot element is located at the candidate cause point.

8. The method of claim 1, wherein the set of historical data and the predictive model are associated with a first object, and generating the user interface further comprises:
generating a third graphical representation of a subsequent set of historical data and a fourth graphical representation of a subsequent predictive model, the third graphical representation and the fourth graphical representation associated with a second object.

9. The method of claim 8, wherein the pivot element intersects one or more graphical representations associated with the first object and one or more graphical representations associated with the second object.

10. The method of claim 1, wherein generating the user interface further comprises:
identifying a time range for the set of historical data;
generating a range element representing the time range; and
generate a time interface element movable along the range element, movement of the time interface element causing presentation of differing portions of the set of historical data.

11. The method of claim 10, wherein the time interface element comprises an indicator portion, the indicator portion including one or more visual indicators configured to provide quick reference data for at least a portion of the time range.

12. A system, comprising:
one or more processors; and
a non-transitory processor-readable storage medium storing processor executable instructions that, when executed by one or more processors of a machine, cause the machine to perform operations comprising:
generating, by one or more processors, a user interface having a first graphical representation of a set of historical data and a second graphical representation of a predictive model, the second graphical representation extending from the first graphical representation;
generating, by the one or more processors, a movable pivot element, the pivot element being a user interface element in a first position on the first graphical representation;
monitoring the pivot element within the user interface to detect a change in position of the pivot element to a second position; and
automatically modifying the predictive model to generate a modified predictive model and modifying the second graphical representation to represent the modified predictive model.

13. The system of claim 12, wherein the operations further comprise:
receiving a view query comprising object data and time data, the object data and the time data being associated with the set of historical data, and the user interface being generated in response to receiving the view query.

14. The system of claim 12, wherein the movable pivot element intersects the first graphical representation and is movable along the first graphical representation.

15. The system of claim 12, wherein the predictive model is generated based on a portion of the set of historical data represented by the first graphical representation extending from a first end of the first graphical representation to the first position of the pivot element.

16. The system of claim 12, wherein the second graphical representation extends from the first graphical representation at a position of the pivot element.

17. The system of claim 12, wherein the operations further comprise:
receiving, by the one or more processors, selection of a candidate cause point within the user interface; and
generating the modified predictive model based on the second position of the pivot element and the candidate cause point.

18. The system of claim 17, wherein the candidate cause point is a point on the first graphical representation after which the second graphical representation deviates from the first graphical representation when the pivot element is located at the candidate cause point.

19. A non-transitory processor-readable storage medium storing processor executable instructions that, when executed by one or more processors of a machine, cause the machine to perform operations comprising:
generating, by one or more processors, a user interface having a first graphical plot of a set of historical data and a second graphical plot of a set of predicted data, the first and second graphical plots comprising a combined graphical plot;
generating, by the one or more processors, a movable pivot element, the pivot element being a user interface element in a first position on the first graphical plot;
monitoring the pivot element within the user interface to detect a change in position of the pivot element to a second position; and
automatically modifying the predictive model to generate a modified predictive model and modifying the second graphical plot to represent the modified predictive model.

20. The non-transitory processor-readable storage medium of claim 19, wherein the operations further comprise:
receiving, by the one or more processors, selection of a candidate cause point within the user interface, the candidate cause point being a point on the first graphical plot after which the second graphical plot deviates from the first graphical plot when the pivot element is located at the candidate cause point; and
generating the modified predictive model based on the second position of the pivot element and the candidate cause point.
